(19) United States
(12) Patent Application Publication
(10) Pub. No.: US 2026/0236769 A1
(43) Pub. Date: Aug. 13, 2026

(54) NEURAL NETWORK LEARNING METHOD AND DEVICE BASED ON DATA PREPROCESSING OPTIMIZATION, AND INFERENCE DEVICE USING THE SAME

(71) Applicant: Hansung University Industry-University Cooperation Foundation, Seoul (KR)

(72) Inventor: Jongtaek Oh, Seoul (KR)

(73) Assignee: Hansung University Industry-University Cooperation Foundation, Seoul (KR)

(21) Appl. No.: 19/540,561

(22) Filed: Feb. 13, 2026

Related U.S. Application Data
(60) Provisional application No. 63/758,252, filed on Feb. 13, 2025.

(51) Int. Cl. G06N 3/08

(52) U.S. Cl. CPC G06N 3/08

(57) ABSTRACT

A computer-implemented neural network training system is disclosed in which a data preprocessing parameter set and a model parameter set are jointly managed and iteratively updated within a unified execution control structure. One or more hardware processors execute instructions stored in non-transitory memory to perform a preprocessing process on raw data using the data preprocessing parameter set, train a neural network model using preprocessed data and the model parameter set, compute a loss value representing an estimation error, and update both the data preprocessing parameter set and the model parameter set based on the loss value. The processors iteratively repeat these operations under control of an iteration control logic until a stopping criterion is satisfied. Accordingly, preprocessing configuration and model configuration are dynamically co-optimized through coordinated modification of structured data stored in memory within a single computing system.

### CROSS REFERENCE TO RELATED APPLICATION

This application claims the benefit of the filing date of U.S. Patent Provisional Application No. 63/758,252, filed Feb. 13, 2025, as Attorney Docket No.: 985.0007prov, the teaches of which are incorporated herein their entirety by reference.

### BACKGROUND

The present disclosure relates generally to computer-implemented machine learning systems, and more particularly to a neural network training architecture in which data preprocessing operations and neural network model training operations are integrally controlled and optimized within a computing system.

In recent years, techniques for estimating target values by training neural networks using large volumes of data have been widely adopted in artificial intelligence and machine learning systems. In many neural network training environments, raw input data is first subjected to one or more preprocessing operations to generate training data, and the generated training data is then used to train a neural network model by updating model parameters such as weights and biases.

Although optimization of a neural network model structure and its weight parameters significantly affects model performance, the characteristics of the training data used for model training may also substantially influence overall system behavior. In particular, the composition, scale, diversity, normalization, dimensionality, and feature representation of training data may directly influence convergence speed, stability of learning, and computational resource utilization within a training system.

In certain neural network training architectures, data preprocessing operations and neural network model training operations may be implemented as separate processing stages within a computing environment. In such configurations, preprocessing methods and associated parameters may be selected in advance or externally configured, and the resulting preprocessed dataset may be supplied to a neural network training routine. If model performance is unsatisfactory, preprocessing configurations may be modified and the training process may be re-executed, potentially requiring repeated data regeneration and additional computational cycles.

Such separation between preprocessing configuration and model training may lead to increased processor workload, repeated memory allocation for regenerated datasets, and delayed convergence of the training process. In addition, when preprocessing parameters are not dynamically integrated into the model training loop, a computing system may be limited in its ability to adapt internal data representations based on intermediate training outcomes.

Some references recognize that preprocessing of raw data may influence neural network modeling performance. However, existing approaches generally treat preprocessing operations as a stage external to the internal model parameter update loop, rather than as a parameterized component that is iteratively modified in coordination with model parameter updates within a unified execution control structure.

Accordingly, there is a need for a computer-implemented neural network training system in which preprocessing configuration and model parameter configuration are jointly managed and iteratively updated within a controlled execution loop, thereby enabling dynamic adjustment of data representation and improved computational efficiency during training.

### SUMMARY

In accordance with one aspect of the present disclosure, a computer-implemented neural network training system is provided in which a data preprocessing parameter set is stored in memory as a structured data set and is treated as a trainable configuration element within a neural network training process, rather than as a fixed preprocessing stage.

In accordance with another aspect of the present disclosure, the system is configured to update both the data preprocessing parameter set and a model parameter set within a unified iterative execution loop based on a computed loss value, thereby co-optimizing data representation and model configuration during training.

In accordance with still another aspect of the present disclosure, the preprocessing operations, model parameter updates, loss evaluation, and stopping criteria are executed under control of an internal iteration control logic of a computing system, such that preprocessing configuration and model configuration are dynamically and repeatedly adjusted within a single controlled training architecture.

In accordance with an embodiment, a neural network training system may include one or more hardware processors and a non-transitory memory storing instructions. When the instructions in the memory are executed by the one or more hardware processors, the one or more hardware processors perform a preprocessing process to which a data preprocessing parameter set is applied to raw data for training a neural network model, thereby generating preprocessed data; train a model parameter set of the neural network model using the preprocessed data, compute a loss value representing an estimation error between an output of the neural network model and reference data, update both the data preprocessing parameter set and the model parameter set by modifying structured data stored in the member based on the computed loss value, and iteratively repeat the preprocessing process, the training of the model parameter set, the computation of the loss value, and the updating of both the data preprocessing parameter set and the model parameter set under control of an iteration control logic until a stopping criterion is satisfied.

The instructions may further cause the one or more hardware processors to initialize the data preprocessing parameter set prior to performing the preprocessing process.

The data preprocessing parameter set may include at least one preprocessing method identifier and at least one preprocessing condition parameter associated with the identified preprocessing method.

The instructions may further cause the one or more hardware processors to update the data preprocessing parameter set using an update rule based on the computed loss value.

The instructions may further cause the one or more hardware processors to modify at least one of weight parameters or a model structure of the neural network model when updating the model parameter set.

The stopping criterion may include at least one of a loss value threshold, a reduction rate of the loss value, or a predetermined number of iterations.

In accordance with another embodiment, a computer-implemented method for training a neural network model may include performing, by one or more hardware processors, a preprocessing process to which a data preprocessing parameter set is applied to raw data, thereby generating preprocessed data, training, by the one or more hardware processors, a model parameter set of the neural network model using the preprocessed data, computing, by the one or more hardware processors, a loss value representing an estimation error between an output of the neural network model and reference data, updating, by the one or more hardware processors, both the data preprocessing parameter set and the model parameter set based on the computed loss value, and iteratively repeating the preprocessing process, the training of the model parameter set, the computing of the loss value, and the updating of both the data preprocessing parameter set and the model parameter set under control of an iteration control logic until a stopping criterion is satisfied.

In accordance with further another embodiment, a non-transitory computer-readable storage medium storing instructions that, when executed by one or more hardware processors, cause the one or more hardware processors to perform operations may include performing a preprocessing process to which a data preprocessing parameter set is applied to raw data, thereby generating preprocessed data, training a model parameter set of a neural network model using the preprocessed data, computing a loss value representing an estimation error between an output of the neural network model and reference data, updating both the data preprocessing parameter set and the model parameter set based on the computed loss value, and iteratively repeating the preprocessing process, the training of the model parameter set, the computing of the loss value, and the updating of both the data preprocessing parameter set and the model parameter set under control of an iteration control logic until a stopping criterion is satisfied.

### BRIEF DESCRIPTION OF THE DRAWINGS

FIG. 1 is a diagram illustrating a neural network learning and inference system according to the present disclosure.

FIG. 2 is a diagram illustrating an example of a system configuration of a neural network learning apparatus.

FIG. 3A is a diagram illustrating a functional configuration of the neural network learning apparatus.

FIG. 3B is a diagram illustrating an architectural implementation of the functional configuration of FIG. 3A in which functional modules are realized as processor-executed engines and memory-stored data structures.

FIG. 4A is a flowchart illustrating a data preprocessing optimization and simultaneous neural network learning method.

FIG. 4B is a flowchart illustrating an execution-oriented implementation of the method of FIG. 4A in which structured parameter sets stored in memory are dynamically accessed and rewritten by one or more hardware processors.

FIG. 5 is a diagram illustrating an example of a model structure of a neural network.

FIG. 6 is a diagram illustrating an example of a data preprocessing optimization and simultaneous neural network learning process applied to image data.

### DETAILED DESCRIPTION OF EMBODIMENTS

The present disclosure provides a computer-implemented neural network training system in which a data preprocessing parameter set and a model parameter set are jointly managed and iteratively updated within a unified execution control structure. In particular, preprocessing configuration is treated as a dynamically adjustable component of the training architecture rather than as a fixed preliminary stage. By integrating preprocessing operations, model parameter updates, loss evaluation, and stopping criteria within a single controlled iteration loop, the disclosed system enables coordinated optimization of data representation and model configuration during training.

In the disclosed architecture, both the data preprocessing parameter set and the model parameter set are stored in memory and are modified by execution of instructions by one or more processors. The iterative control structure evaluates a loss value representing an estimation error and dynamically adjusts the stored parameter sets based on the evaluated loss value. As a result, data representation and neural network configuration are co-optimized within the computing system.

The embodiments of the present disclosure will now be described in detail with reference to the accompanying drawings.

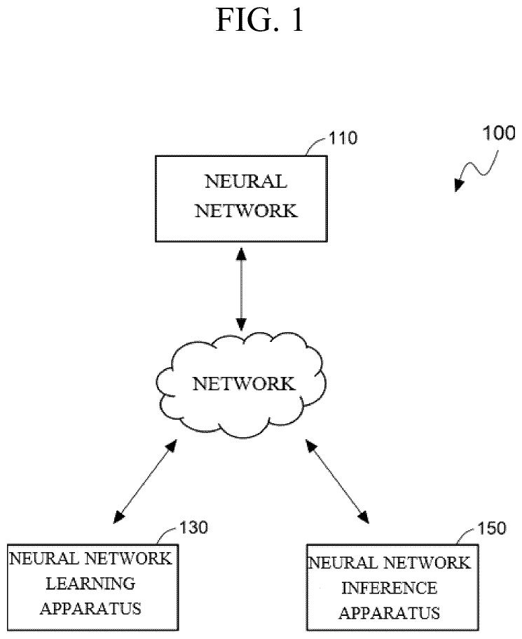

FIG. 1 is a diagram illustrating a neural network learning and inference system according to the present disclosure.

Referring to FIG. 1, a neural network learning and inference system 100 may include a neural network 110, a neural network learning apparatus 130, and a neural network inference apparatus 150. The neural network learning and inference system 100 may provide a data preprocessing optimization and simultaneous neural network learning method that improves coordination between data preprocessing and neural network training (e.g., maximizes learning efficiency and accuracy) by improving a typical approach in which data processing and neural network learning have been independently optimized, and instead integrally optimizing data preprocessing and neural network learning simultaneously.

The neural network 110 may correspond to a multilayer computational model forming a neural network structure composed of nodes and edges. For example, the neural network 110 may include an artificial neural network (ANN), a convolutional neural network (CNN), a recurrent neural network (RNN), and a long short-term memory network (LSTM), without being limited thereto.

The neural network 110 may include learnable model parameters such as weights and biases. Each node of the neural network 110 may correspond to an artificial neuron that processes input data and generates an output and may adjust the output through a bias. Each edge of the neural network 110 may be at least one of a forward path, a reverse path, or a recurrent edge between nodes in the same layer, and a weight may be assigned thereto.

Although FIG. 1 illustrates the neural network 110 as being independent from the neural network learning apparatus 130 or the neural network inference apparatus 150, the neural network 110 is not limited thereto and may be implemented as a component included within each apparatus.

The neural network learning apparatus 130 may perform the neural network learning method based on data preprocessing optimization according to the present disclosure and may be implemented to include hardware and software modules that implement the method. For example, the neural network learning apparatus 130 may include a processor, a memory, and an optimization algorithm, and may sequentially process operations such as data preprocessing, neural network learning, parameter optimization, and iteration control.

The neural network learning apparatus 130 may be connected to the neural network inference apparatus 150 via a wired or wireless network and may provide an optimized neural network model to the neural network inference apparatus 150. Although FIG. 1 illustrates the neural network learning apparatus 130 and the neural network inference apparatus 150 as separate devices, the present disclosure is not limited thereto, and one apparatus may be implemented to include the other apparatus as a component.

The neural network inference apparatus 150 may correspond to a device that generates an inference result for given input data using one or more neural network models constructed through the neural network learning method based on data preprocessing optimization according to the present disclosure and may be implemented to include hardware and software modules for this purpose. The one or more neural network models may include neural network models whose model parameters have been updated at least once during a repeated neural network learning process. The neural network inference apparatus 150 may be implemented as an edge device, a high-performance PC, or a cloud server capable of providing neural network inference services. The neural network inference apparatus 150 may perform operations related to real-time inference or performance monitoring and may manage versions of neural network models in conjunction with the neural network learning apparatus 130 or request retraining based on data collected during inference.

For purposes of clarity, the term “Neural Network Learning Apparatus” 130 may also be referred to as a “Neural Network Training System,” a “Computing System,” or a “Computing Device,” and may include one or more hardware processors and non-transitory memory storing executable instructions. Similarly, the term “Neural Network Inference Apparatus” 150 may also be referred to as a “Neural Network Inference System” or an “Inference Engine.” The term “Neural Network” 110 may correspond to a neural network model executed by one or more processors.

These alternative terms are used interchangeably to describe equivalent structural and functional components and do not introduce new subject matter beyond the scope of the provisional disclosure.

In some embodiments, the neural network learning and inference system 100 is implemented as a computing system including one or more hardware processors and non-transitory memory storing instructions that, when executed, cause the processors to perform integrated preprocessing and neural network training operations. The neural network learning apparatus 130 stores in memory a data preprocessing parameter set and a model parameter set and executes instructions that iteratively modify the stored parameter sets based on evaluation of a loss value computed during execution of the neural network 110.

Accordingly, preprocessing configuration and model configuration are dynamically co-optimized within the computing system rather than being externally controlled or statically predetermined. An iteration control logic executed by the one or more processors evaluates a stopping criterion and controls repeated execution of preprocessing operations, model parameter updates, and loss evaluation within a unified execution loop.

The neural network inference apparatus 150 executes the neural network model using the optimized model parameter set stored in memory and generates inference outputs based on the dynamically optimized data representation and model configuration.

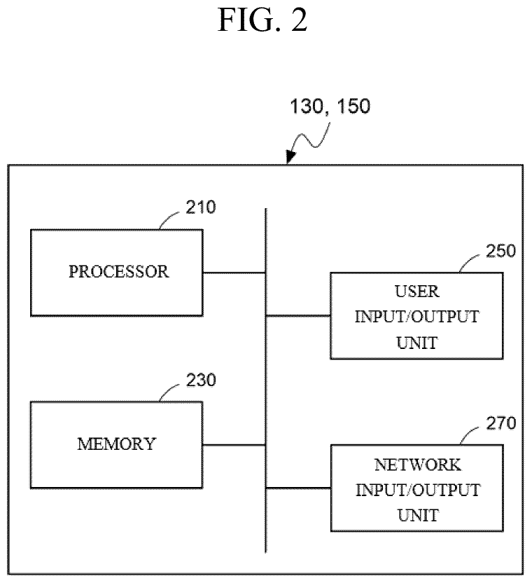

FIG. 2 is a diagram illustrating an example of a system configuration of a neural network learning apparatus according to the present disclosure.

Referring to FIG. 2, the neural network learning apparatus 130 may include a processor 210, a memory 230, a user input/output unit 250, and a network input/output unit 270. In addition, the neural network inference apparatus 150 may be implemented with the same configuration as the neural network learning apparatus 130. Hereinafter, the configuration of the neural network learning apparatus 130 will be mainly described.

The processor 210 may execute procedures for performing the neural network learning method based on data preprocessing optimization according to the present disclosure, may manage the memory 230 that is read from or written to during this process, and may schedule synchronization time between volatile memory and non-volatile memory in the memory 230. The processor 210 may control the overall operation of the neural network learning apparatus 130 and may be electrically connected to the memory 230, the user input/output unit 250, and the network input/output unit 270 to control data flow therebetween. The processor 210 may be implemented as a central processing unit (CPU), a graphic processing unit (GPU), a neural processing unit (NPU), or the like, without being limited thereto.

The memory 230 may include a secondary storage device implemented as non-volatile memory such as a solid state disk (SSD) or a hard disk drive (HDD) for storing overall data required for the neural network learning apparatus 130 and may include a main storage device implemented as volatile memory such as random access memory (RAM). The memory 230 may store a set of instructions for executing the present disclosure, and when the instructions are executed by the processor 210 electrically connected thereto, the neural network learning method based on data preprocessing optimization according to the present disclosure may be performed.

The user input/output unit 250 may include an environment for receiving user input and an environment for outputting specific information to a user. For example, the user input/output unit 250 may include an input device including an adapter such as a touch pad, a touch screen, a virtual keyboard, or a pointing device, and may include an output device including an adapter such as a monitor or a touch screen. In one embodiment, the user input/output unit 250 may correspond to a terminal connected via remote access. In such a case, the neural network learning apparatus 130 may correspond to an independent node of a network to which the terminal is connected.

The network input/output unit 270 may provide a communication environment for connection with other devices via a network and may include an adapter for communication through a local area network (LAN), a metropolitan area network (MAN), a wide area network (WAN), or a value added network (VAN). In addition, the network input/output unit 270 may be implemented to provide short-range communication functions such as WiFi or Bluetooth, or wireless communication functions of 4G or higher for wireless data transmission.

For purposes of clarity, the term “processor” 210 may refer to one or more hardware processors or processing circuitry configured to execute machine learning instructions. The term “memory” 230 may include volatile memory, non-volatile memory, or any non-transitory computer-readable storage medium storing executable instructions and structured data sets. The user input/output unit 250 may also be referred to as a user interface or I/O interface, and the network input/output unit 270 may also be referred to as a network interface or communication interface.

These terms are used interchangeably to describe equivalent structural and functional components and do not introduce new subject matter beyond the scope of the provisional disclosure.

In some embodiments, the processor 210 executes instructions stored in the memory 230 to implement an integrated preprocessing and model training control structure in which a data preprocessing parameter set and a model parameter set are stored as structured data within the memory. The processor 210 reads and modifies the stored parameter sets during execution of an iterative training routine, and writes updated parameter values back to the memory.

The memory 230 may further store a loss function, a stopping criterion, and an iteration control logic that are accessed and executed by the processor 210 to control repeated execution of preprocessing operations, model parameter updates, and loss evaluation within a unified training loop. Accordingly, the hardware configuration illustrated in FIG. 2 supports dynamic co-optimization of preprocessing configuration and neural network model configuration within a single computing system.

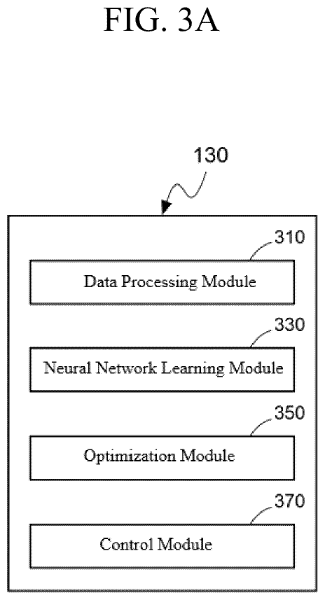

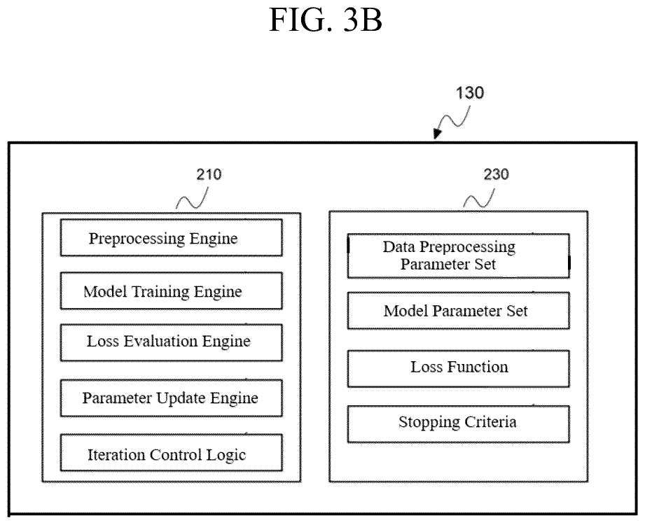

FIG. 3A illustrates a functional configuration of the neural network learning apparatus. FIG. 3B illustrates a structural implementation of the functional configuration shown in FIG. 3A in which the functional modules are realized as processor-executed engines and memory-stored data structures within a computing system.

In one embodiment, FIG. 3A represents a functional module view of the neural network learning apparatus 130, whereas FIG. 3B represents an architectural implementation view in which the functional modules are executed by one or more hardware processors and interact with structured data sets stored in non-transitory memory.

Referring to FIG. 3A, the neural network learning apparatus 130 may include a data processing module 310. The data processing module 310 may perform an operation of generating preprocessed data by performing a preprocessing process to which preprocessing parameters are applied to raw data for training a neural network. That is, the data processing module 310 may perform a preprocessing operation by applying one or more preprocessing methods based on a raw dataset and may generate one or more pieces of preprocessed data from a single piece of raw data through the preprocessing operation. The preprocessed data generated by the data processing module 310 may be included in a training dataset for neural network learning.

For purposes of clarity, the term “Data Processing Module” 310 shown in FIG. 3A may correspond, in FIG. 3B, to a preprocessing engine executed by one or more hardware processors. In addition, preprocessing parameters described in FIG. 3A may correspond to a data preprocessing parameter set stored in memory as a structured data set including at least one preprocessing method identifier and at least one preprocessing condition parameter. These terms describe equivalent structural and functional components.

Referring to FIG. 3B, in one embodiment, the preprocessing engine is implemented as executable instructions stored in non-transitory memory and executed by one or more hardware processors. The data preprocessing parameter set may be stored in memory as a structured data set.

During execution of an iterative training routine, the one or more hardware processors may read the data preprocessing parameter set from memory, apply the identified preprocessing method to stored raw input data, generate preprocessed data, and store the generated preprocessed data in memory as training data. The processors may subsequently modify the data preprocessing parameter set based on a computed loss value and rewrite updated parameter values to memory. Accordingly, preprocessing configuration is dynamically adjusted through processor execution and memory updates within a unified training architecture.

Referring to FIG. 3A, the neural network learning apparatus 130 may include a neural network learning module 330. The neural network learning module 330 may perform an operation of training model parameters of a neural network using preprocessed data and calculating an estimation error of the neural network. The model parameters may include a type and structure of the neural network model and parameters that determine an operation method thereof. The neural network learning module 330 may adjust weights representing connection strengths between neurons and biases determining activation of respective neurons so as to reduce the estimation error.

The neural network learning module 330 may calculate the estimation error to evaluate performance of the trained neural network model. The estimation error may represent a difference between a predicted value and a reference value. The estimation error may be computed using, for example, a mean squared error method, a cross-entropy error method, or other evaluation metrics.

For purposes of clarity, the term “Neural Network Learning Module” 330 shown in FIG. 3A may correspond, in FIG. 3B, to a model training engine executed by one or more hardware processors. The term “model parameters” may correspond to a model parameter set stored in memory as structured data including trainable weight parameters and, in some embodiments, model structure configuration data. The term “estimation error” may correspond to a loss value computed using a loss function stored in memory. These terms describe equivalent structural and functional components.

Referring to FIG. 3B, in one embodiment, the model training engine is implemented as executable instructions stored in non-transitory memory and executed by one or more hardware processors. The model parameter set is stored in memory as structured data including trainable weight parameters associated with the neural network model.

During execution of an iterative training routine, the one or more hardware processors may read the model parameter set from memory, execute the neural network model using the preprocessed data, compute a loss value using a stored loss function, and update the model parameter set based on the computed loss value. Updated model parameter values may be written back to memory. Accordingly, the neural network learning functionality of FIG. 3A is implemented in FIG. 3B as processor-executed operations that modify structured model parameter data stored in memory.

Referring to FIG. 3A, the neural network learning apparatus 130 may include an optimization module 350. The optimization module 350 may perform an operation of updating preprocessing parameters and model parameters in a direction in which an estimation error decreases. The preprocessing parameters may affect characteristics of training data, and the model parameters may affect output behavior of the neural network. Accordingly, the optimization module 350 may coordinate updating of preprocessing configuration and model configuration so as to improve performance of the neural network learning process.

The optimization module 350 may update the preprocessing parameters using, for example, an update rule including a derivative-based technique (e.g., a partial derivative of the estimation error with respect to the preprocessing parameters) or by modifying preprocessing parameters according to a predetermined update rule. The optimization module 350 may also update weight parameters of the neural network or modify a model structure.

For purposes of clarity, the term “Optimization Module” 350 shown in FIG. 3A may correspond, in FIG. 3B, to a parameter update engine executed by one or more hardware processors. The updating of preprocessing parameters may correspond to modifying a data preprocessing parameter set stored in memory. The updating of model parameters may correspond to modifying a model parameter set stored in memory. The estimation error described in FIG. 3A may correspond to a loss value computed using a loss function stored in memory. These terms describe equivalent structural and functional components.

Referring to FIG. 3B, in one embodiment, the parameter update engine is implemented as executable instructions stored in non-transitory memory and executed by one or more hardware processors. The parameter update engine may receive a computed loss value and determine updated versions of both the data preprocessing parameter set and the model parameter set based on the loss value.

The one or more hardware processors may read the current parameter sets from memory, apply an update rule to generate modified parameter values, and rewrite the updated parameter sets to memory. Accordingly, preprocessing configuration and model configuration are co-optimized through coordinated modification of structured data stored in memory. The parameter update engine may operate within a unified iterative execution loop controlled by an iteration control logic.

Referring to FIG. 3A, the neural network learning apparatus 130 may include a control module 370. The control module 370 may control overall operation of the neural network learning apparatus and may manage control flow or data flow among the data processing module 310, the neural network learning module 330, and the optimization module 350. The control module 370 may perform an operation of repeatedly executing preprocessing, neural network learning, and parameter optimization steps based on updated preprocessing parameters and model parameters.

The control module 370 may determine whether a stopping criterion is satisfied based on an estimation error. For example, the stopping criterion may include a threshold value of the estimation error, a reduction rate of the estimation error, or a predetermined number of iterations. When the stopping criterion is satisfied, the control module 370 may terminate repeated execution of the training process.

For purposes of clarity, the term “Control Module” 370 shown in FIG. 3A may correspond, in FIG. 3B, to an iteration control logic executed by one or more hardware processors. The stopping criterion described in FIG. 3A may correspond to a stopping criterion stored in memory and accessed during execution of an iterative training routine. The repeated execution of preprocessing and parameter updates may correspond to iterative execution of processor instructions that read and modify structured parameter sets stored in memory. These terms describe equivalent structural and functional components.

Referring to FIG. 3B, in one embodiment, the iteration control logic is implemented as executable instructions stored in non-transitory memory and executed by one or more hardware processors. The iteration control logic may coordinate execution of the preprocessing engine, the model training engine, and the parameter update engine within a unified training loop.

During execution, the one or more hardware processors may evaluate a loss value and compare the loss value with one or more stopping criteria stored in memory. If the stopping criteria are not satisfied, the processors may trigger another iteration of preprocessing, model training, and parameter updating. If the stopping criteria are satisfied, the processors may terminate the iterative training routine. Accordingly, the control functionality of FIG. 3A is realized in FIG. 3B as processor-executed iteration control logic that governs dynamic co-optimization of preprocessing configuration and model configuration.

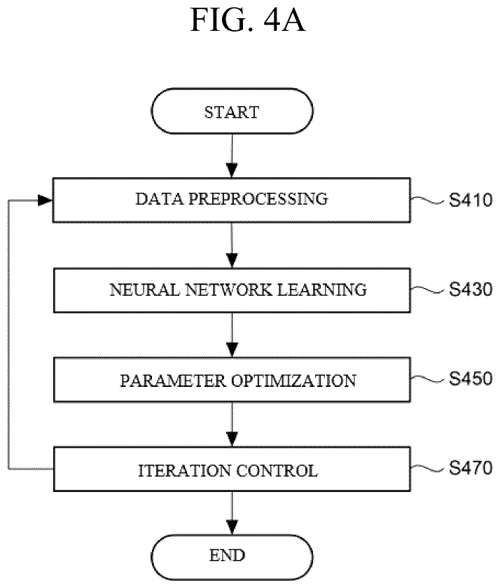

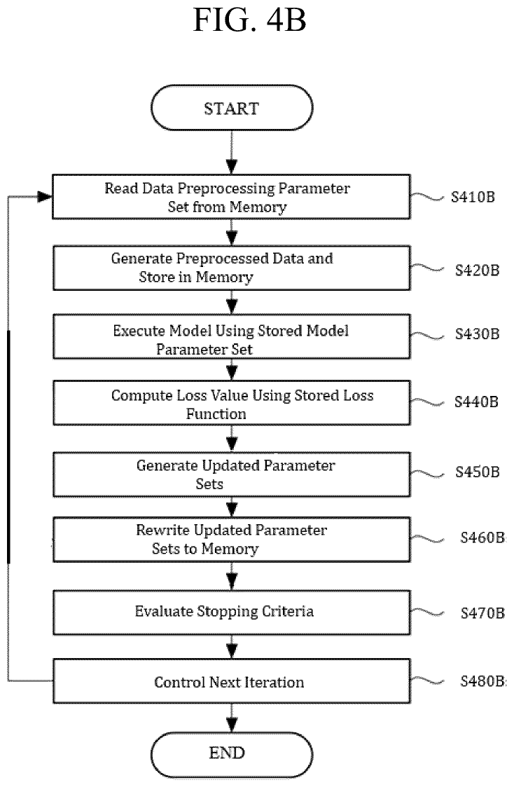

FIG. 4A is a flowchart illustrating a data preprocessing optimization and simultaneous neural network learning method.

Referring to FIG. 4A, the neural network learning apparatus 130 may perform a first step (S410) of performing, through the processor 210, a preprocessing process to which preprocessing parameters are applied to raw data for training a neural network, thereby generating preprocessed data.

The neural network learning apparatus 130 may perform, through the processor 210, a second step (S430) of training model parameters of the neural network using the preprocessed data and calculating an estimation error of the neural network.

In addition, the neural network learning apparatus 130 may perform, through the processor 210, a third step (S450) of simultaneously updating the preprocessing parameters and the model parameters in a direction in which the estimation error decreases.

The neural network learning apparatus 130 may perform, through the processor 210, a fourth step (S470) of repeatedly performing the first to third steps based on the updated preprocessing parameters and the updated model parameters.

In this case, the neural network learning apparatus 130 may fix the preprocessing parameters and repeatedly perform neural network learning. When the estimation error becomes smaller than a predetermined criterion, when a predetermined number of repetitions is reached, or when the estimation error no longer decreases, the neural network learning apparatus 130 may update the preprocessing parameters randomly or using derivative-based update rule (e.g., a partial derivative method).

That is, the neural network learning apparatus 130 may store and fix the model structure, model parameters, and estimation error of the neural network at a point when the estimation error becomes smaller than a predetermined criterion, when a predetermined number of repetitions is reached, or when the estimation error no longer decreases. The neural network learning apparatus 130 may then update the preprocessing parameters while inputting training data generated according to the updated preprocessing parameters into the neural network in a direction in which the estimation error decreases.

Even in this case, the neural network learning apparatus 130 may repeatedly perform preprocessing learning until the estimation error becomes smaller than a predetermined criterion, a predetermined number of repetitions is reached, or the estimation error no longer decreases.

In addition, the neural network learning apparatus 130 may repeatedly perform updating of preprocessing methods and parameters and updating of the model structure and model parameters of the neural network. The neural network learning apparatus 130 may include a process of changing a stopping method or stopping criteria during the repeated process.

That is, even when a specific stopping criterion is satisfied, if a stopping method is changed, the neural network learning process may be additionally repeated until a stopping criterion according to the changed stopping method is satisfied. In addition, the neural network learning apparatus 130 may predict a stopping time point according to a current stopping criterion through the control module 370 and may change a stopping method before reaching the predicted stopping time point.

In this case, the neural network learning apparatus 130 may apply a plurality of stopping methods in parallel and may terminate the repeated process when any one of the plurality of stopping methods is satisfied, when a predetermined number of stopping methods is satisfied, or when all stopping methods are satisfied.

Further, the neural network learning apparatus 130 may randomly change and apply a stopping method or stopping criteria whenever neural network learning is repeatedly performed so that the estimation error decreases. The neural network learning apparatus 130 may fix a stopping method or stopping criteria and repeatedly perform neural network learning, and when the estimation error becomes smaller than a predetermined criterion, when a predetermined number of repetitions is reached, or when the estimation error no longer decreases, may update the stopping method or stopping criteria randomly or using derivative-based update rule (e.g., a partial derivative method).

In another embodiment, the functional flow illustrated in FIG. 4A is implemented as an execution-oriented architecture as shown in FIG. 4B. In this embodiment, the preprocessing parameters and the model parameters are stored as structured data sets in non-transitory memory and are dynamically accessed and rewritten by one or more hardware processors during iterative training. Accordingly, the operations described functionally in FIG. 4A are realized as processor-executed instructions that modify stored data structures within a unified training control loop.

Referring to FIG. 4B, at step S410B, one or more hardware processors may read a data preprocessing parameter set from non-transitory memory.

At step S420B, the one or more hardware processors may apply a preprocessing method identified in the data preprocessing parameter set to raw input data stored in memory, generate preprocessed data, and store the generated preprocessed data in memory as training data.

At step S430B, the one or more hardware processors may read a model parameter set from memory and execute a neural network model using the stored training data and the stored model parameter set.

At step S440B, the one or more hardware processors may compute a loss value using a loss function stored in memory, the loss value representing an estimation error between an output of the neural network model and reference data stored in memory.

At step S450B, the one or more hardware processors may generate updated versions of both the data preprocessing parameter set and the model parameter set based on the computed loss value and a predetermined update rule.

At step S460B, the one or more hardware processors may rewrite the updated data preprocessing parameter set and the updated model parameter set to memory, thereby modifying structured data sets stored in memory.

At step S470B, the one or more hardware processors may evaluate one or more stopping criteria stored in memory by comparing the computed loss value with at least one threshold or iteration condition.

At step S480B, if the stopping criteria are not satisfied, the one or more hardware processors may initiate another iteration beginning at step S410B, and if the stopping criteria are satisfied, the one or more hardware processors may terminate the iterative training routine.

Accordingly, FIG. 4B represents an execution-oriented control architecture in which preprocessing configuration and model configuration are co-optimized through coordinated rewriting of structured data stored in memory under control of an iteration control logic executed by one or more hardware processors.

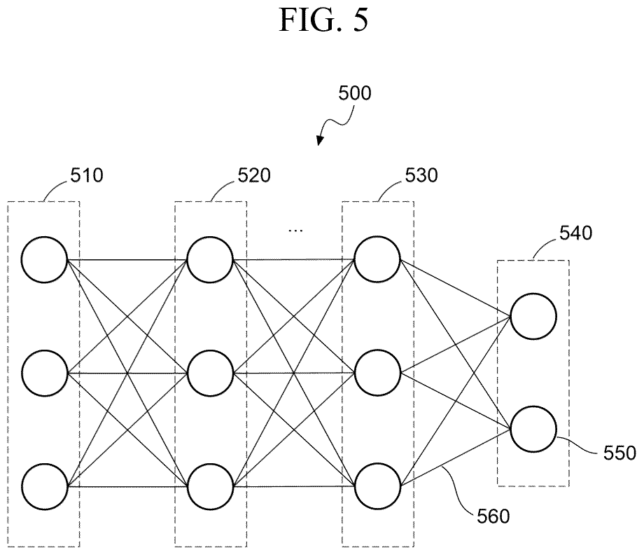

FIG. 5 is a diagram illustrating an example of a model structure of a neural network according to the present disclosure.

Referring to FIG. 5, a neural network 500 may include an input layer 510, one or more hidden layers 520 and 530, and an output layer 540. Each of the input layer 510, the one or more hidden layers 520 and 530, and the output layer 540 may include one or more nodes 550. The nodes 550 may be connected through edges 560. Each node 550 may be assigned a bias, and each edge 560 may be assigned a weight.

The neural network 500 may be trained through neural network learning performed in the neural network learning apparatus 130. For this purpose, the neural network learning apparatus 130 may prepare training data including input data and a corresponding label for the input data. The neural network learning apparatus 130 may initialize weight values and bias values of the neural network 500 and may update the values through a learning process. The neural network learning apparatus 130 may optimize learning hyperparameters such as a learning rate and a dropout rate to prevent overfitting and ensure learning performance.

Specifically, input data may be input through the input layer 510 of the neural network 500, and each node 550 of the input layer 510 may receive the input data, apply an activation function, and transmit a result to nodes 550 of the next hidden layer 520. Each node 550 of the hidden layers 520 and 530 may apply an activation function to a value received from a previous layer and transmit a result to a next layer, and this process may be repeated up to the output layer 540. Finally, a predicted value may be generated and output from the output layer 540 of the neural network 500.

In addition, the neural network 500 may generate an inference result through an inference process performed in the neural network inference apparatus 150. For this purpose, the neural network inference apparatus 150 may prepare new input data for inference and may input the input data into the input layer 510 of the neural network 500. The neural network 500 may generate a predicted value in the output layer 540 through the same computational process as described in the learning process. The neural network inference apparatus 150 may generate a final inference result based on the predicted value generated in the output layer 540. The predicted value may have various forms depending on an inference objective, such as classification, regression, or detection.

For purposes of clarity, the term “Neural Network” 500 may correspond to a neural network model executed by one or more hardware processors. The weight values and bias values assigned to the edges 560 and nodes 550 may correspond to a model parameter set stored in non-transitory memory as structured data. The input layer 510, hidden layers 520 and 530, and output layer 540 may correspond to a model structure configuration stored in memory. These terms describe equivalent structural and functional components.

In another embodiment, the neural network 500 is implemented as executable instructions stored in non-transitory memory and executed by one or more hardware processors. The model parameter set, including weight parameters and bias parameters, may be stored in memory as structured data indexed according to layer identifiers and node identifiers.

During execution of a training routine, the one or more hardware processors may read the model structure configuration and the model parameter set from memory, perform forward propagation using stored weight and bias parameters, compute intermediate activation values, and generate an output value at the output layer 540. The processors may compute a loss value using a stored loss function and update the model parameter set by modifying stored weight and bias values and rewriting updated parameter values to memory.

Accordingly, the neural network structure illustrated in FIG. 5 is realized as processor-executed operations that read, compute, and rewrite structured model parameter data stored in memory within a unified training architecture.

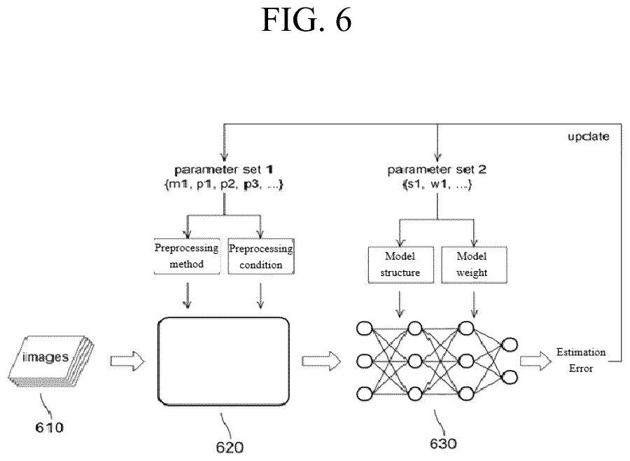

FIG. 6 is an example diagram illustrating a data preprocessing optimization and simultaneous neural network learning process according to the present disclosure.

Referring to FIG. 6, the neural network learning apparatus 130 may receive image data 610 as input and may preprocess the image data 610 using an image processing and computer vision program package such as openCV to generate training image data. The neural network learning apparatus 130 may input the training image data into a neural network 630 to estimate a target value.

Specifically, the neural network learning apparatus 130 may perform a data preprocessing process through a data processing module 620 and may determine preprocessing methods to be applied to the preprocessing process in consideration of characteristics of raw data and an inference objective. During repeated neural network learning, the neural network learning apparatus 130 may change or update at least one of preprocessing methods and preprocessing conditions through preprocessing parameters.

In addition, the neural network learning apparatus 130 may perform updating of model parameters applied to neural network learning together with updating of the preprocessing parameters. That is, the neural network learning apparatus 130 may change or update at least one of a model structure and weight parameters of the neural network 630 through the model parameters.

In addition, the neural network learning apparatus 130 may simultaneously update the preprocessing parameters and the model parameters and may, if necessary, repeatedly perform neural network learning while fixing one of the preprocessing parameters and the model parameters.

For example, an image data processing function included in openCV may include input parameters that must be set to appropriate values. A function such as “cv::cornerHarris” may include parameters such as neighborhood size, aperture size, and a Harris parameter. Depending on the values of such parameters, output data indicating a possibility of a corner at each input image pixel may vary.

The generated output data may be used as training data for the neural network 630. Learning speed or estimation error accuracy of the neural network may vary depending on characteristics of the training data. Accordingly, preprocessing configuration and associated parameters may influence neural network training behavior.

In particular, one issue that may arise during neural network learning is overfitting of a model structure or edge weight parameters to the training data. Although a dropout method may be used to mitigate such overfitting, overfitting may also be reduced by modifying preprocessing methods or changing preprocessing parameters during training so that the neural network learns from training data having different representational forms.

For purposes of clarity, the image processing functions described in FIG. 6 may correspond to preprocessing engines executed by one or more hardware processors. The preprocessing parameters associated with such functions may correspond to a data preprocessing parameter set stored in non-transitory memory as structured data. The neural network 630 may correspond to a neural network model whose weight parameters are included in a model parameter set stored in memory. These terms describe equivalent structural and functional components.

In another embodiment, the raw image data 610 is stored in non-transitory memory and accessed by one or more hardware processors. The processors may read a data preprocessing parameter set from memory and execute preprocessing instructions corresponding to an identified image processing function.

The processors may generate preprocessed training data and store the generated training data in memory. The processors may then read a model parameter set from memory and execute a neural network model 630 using the stored training data.

A loss value may be computed using a loss function stored in memory, and updated versions of both the data preprocessing parameter set and the model parameter set may be generated based on the loss value. The processors may rewrite the updated parameter sets to memory, thereby dynamically modifying structured data that defines both data representation and model configuration.

Through repeated execution of this process under control of an iteration control logic executed by one or more hardware processors, preprocessing configuration and neural network configuration are co-optimized within a unified computing system.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

The present disclosure can be embodied in the form of methods and apparatuses for practicing those methods. The present disclosure can also be embodied in the form of program code embodied in tangible media, non-transitory media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present disclosure can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present disclosure can also be embodied in the form of a bitstream or other sequence of signal values electrically or optically transmitted through a medium, stored magnetic-field variations in a magnetic recording medium, etc., generated using a method and/or an apparatus of the present invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

As used herein in reference to an element and a standard, the term “compatible” means that the element communicates with other elements in a manner wholly or partially specified by the standard and would be recognized by other elements as sufficiently capable of communicating with the other elements in the manner specified by the standard. The compatible element does not need to operate internally in a manner specified by the standard.

No claim element herein is to be construed under the provisions of 35 U.S.C. § 112, sixth paragraph, unless the element is expressly recited using the phrase “means for” or “step for.”

Although embodiments of the present invention have been described herein, it should be understood that the foregoing embodiments and advantages are merely examples and are not to be construed as limiting the present invention or the scope of the claims. Numerous other modifications and embodiments can be devised by those skilled in the art that will fall within the spirit and scope of the principles of this disclosure, and the present teaching can also be readily applied to other types of apparatuses. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A neural network training system comprising:
one or more hardware processors; and
a non-transitory memory storing instructions that, when executed by the one or more hardware processors, cause the one or more hardware processors to:
perform a preprocessing process to which a data preprocessing parameter set is applied to raw data for training a neural network model, thereby generating preprocessed data;
train a model parameter set of the neural network model using the preprocessed data;
compute a loss value representing an estimation error between an output of the neural network model and reference data;
update both the data preprocessing parameter set and the model parameter set by modifying structured data stored in the member based on the computed loss value; and
iteratively repeat the preprocessing process, the training of the model parameter set, the computation of the loss value, and the updating of both the data preprocessing parameter set and the model parameter set under control of an iteration control logic until a stopping criterion is satisfied.

2. The neural network training system of claim 1, wherein the instructions further cause the one or more hardware processors to initialize the data preprocessing parameter set prior to performing the preprocessing process.

3. The neural network training system of claim 1, wherein the data preprocessing parameter set includes at least one preprocessing method identifier and at least one preprocessing condition parameter associated with the identified preprocessing method.

4. The neural network training system of claim 1, wherein the instructions further cause the one or more hardware processors to update the data preprocessing parameter set using an update rule based on the computed loss value.

5. The neural network training system of claim 1, wherein the instructions further cause the one or more hardware processors to modify at least one of weight parameters or a model structure of the neural network model when updating the model parameter set.

6. The neural network training system of claim 1, wherein the stopping criterion includes at least one of a loss value threshold, a reduction rate of the loss value, or a predetermined number of iterations.

7. A computer-implemented method for training a neural network model, the method comprising:
performing, by one or more hardware processors, a preprocessing process to which a data preprocessing parameter set is applied to raw data, thereby generating preprocessed data;
training, by the one or more hardware processors, a model parameter set of the neural network model using the preprocessed data;
computing, by the one or more hardware processors, a loss value representing an estimation error between an output of the neural network model and reference data;
updating, by the one or more hardware processors, both the data preprocessing parameter set and the model parameter set based on the computed loss value; and
iteratively repeating the preprocessing process, the training of the model parameter set, the computing of the loss value, and the updating of both the data preprocessing parameter set and the model parameter set under control of an iteration control logic until a stopping criterion is satisfied.

8. The method of claim 7, further comprising initializing the data preprocessing parameter set prior to performing the preprocessing process.

9. The method of claim 7, wherein the data preprocessing parameter set includes at least one preprocessing method identifier and at least one preprocessing condition parameter.

10. The method of claim 7, wherein updating the data preprocessing parameter set includes applying an update rule based on the computed loss value.

11. The method of claim 7, wherein updating the model parameter set includes modifying at least one of weight parameters or a model structure of the neural network model.

12. The method of claim 7, wherein the stopping criterion includes at least one of a loss value threshold, a reduction rate of the loss value, or a predetermined number of iterations.

13. A non-transitory computer-readable storage medium storing instructions that, when executed by one or more hardware processors, cause the one or more hardware processors to perform operations comprising:
performing a preprocessing process to which a data preprocessing parameter set is applied to raw data, thereby generating preprocessed data;
training a model parameter set of a neural network model using the preprocessed data;
computing a loss value representing an estimation error between an output of the neural network model and reference data;
updating both the data preprocessing parameter set and the model parameter set based on the computed loss value; and
iteratively repeating the preprocessing process, the training of the model parameter set, the computing of the loss value, and the updating of both the data preprocessing parameter set and the model parameter set under control of an iteration control logic until a stopping criterion is satisfied.

14. The non-transitory computer-readable storage medium of claim 13, wherein the data preprocessing parameter set includes at least one preprocessing method identifier and at least one preprocessing condition parameter.

15. The non-transitory computer-readable storage medium of claim 13, wherein updating the data preprocessing parameter set and the model parameter set includes rewriting structured data sets stored in memory.
